(19) United States
(12) Patent Application Publication
(10) Pub. No.: US 2021/0201154 A1
(43) Pub. Date: Jul. 1, 2021

(54) ADVERSARIAL NETWORK SYSTEMS AND METHODS

(71) Applicant: Amobee, Inc., Redwood City, CA (US)

(72) Inventors: Alon Rozental, Tel Aviv (IL); Daniel Fleischer, Rehovot (IL)

(21) Appl. No.: 16/730,884

(22) Filed: Dec. 30, 2019

(51) Int. Cl. G06N 3/08; G06N 20/10; G06K 9/62; G06F 16/9032

(52) U.S. Cl. CPC G06N 3/084; G06N 20/10; G06F 16/9032; G06K 9/628; G06K 9/6269

(57) ABSTRACT

Methods, and systems for determining or inferring user attributes and/or determining information related to user attributes. One of the methods includes: receiving, at each encoder of a plurality of encoders, individual user datasets for a plurality of individual users from a single specified source, the plurality of encoders receiving data from a plurality of data sources; generating a plurality of vectors, wherein generating a plurality of vectors comprises, for each individual user dataset, generating a vector of a specified size, the plurality of vectors forming a shared representation and wherein each of the plurality of encoders comprises a machine learning model trained based at least in part on: a) an encoder's loss, and b) a classifier loss; receiving a query of the shared representation; and providing information from the shared representation in response to the query.

### TECHNICAL FIELD

This specification relates to using neural networks to make predictions from multiple different data sources.

### BACKGROUND

Neural networks, or for brevity, networks, are machine learning models that employ multiple layers of operations to predict one or more outputs from one or more inputs. Neural networks typically include one or more hidden layers situated between an input layer and an output layer. The output of each layer is used as input to another layer in the network, e.g., the next hidden layer or the output layer. Each layer of a neural network specifies one or more transformation operations to be performed on input to the layer. Some neural network layers have operations that are referred to as neurons. Each neuron receives one or more inputs and generates an output that is received by another neural network layer. Often, each neuron receives inputs from other neurons, and each neuron provides an output to one or more other neurons.

Neural networks can be used to make predictions about co-occurrences in datasets. For example, if a dataset includes information about TV shows that users watched, a neural network can be trained to predict, for an unseen user, which TV shows the unseen user would be interested in watching.

However, making such predictions across multiple datasets introduces a problem: neural networks (and other machine learning techniques) have a tendency to treat data elements from the same group as being similar. In other words, neural networks tend to learn the sources of the data rather than any underlying trends that could be used to make useful predictions. For example, a naively trained neural network classifier might simply group all Internet users as close together and all TV users as close together, when in reality this information was already evident from the different data sources themselves.

### SUMMARY

This specification describes technologies for determining or inferring user attributes and/or determining information related to user attributes from multiple different datasets. Various datasets can provide information about individuals. Each dataset can have unique features. From these datasets, one may want to determine or infer some of a user's attributes (such as approximate age) from such datasets.

To do so, the techniques described below result in machine-learned encoders that generate user representations having the following desirable properties for making predictions from multiple different datasets:

1) The encoders will treat users having overlapping attributes from different datasets as being similar:

2) It will be difficult or impossible to determine from which dataset an encoder's user representation was generated: and

3) The user representations will be useful for performing higher-level classifications.

Regarding property (2), a system can use a Generative Adversarial Network (GAN) to obscure the source of a user representation. However, training a GAN can result in a degenerate model that merely generates a constant value for all inputs or that generates random noise. Both of these degenerate models satisfy property (2) by making it difficult or impossible to determine from which dataset the user representation comes from, but they are not models that can be used to make useful predictions.

Thus, in order to also achieve property (3), the training process can also involve training one or more downstream classifiers. The various classifiers can be trained over the intermediate versions of the encoders to perform one or more respective real-world problems such as:
Finding a website that will be favored by the audience of a TV show.
Transferring knowledge learned about a subgroup from one dataset to a subgroup from another dataset.
Finding the most similar user in one dataset to a user in another dataset.

Then, a loss function can enforce all of properties (1), (2), and (3), such that training using backpropagation through the entire network results in encoders that generate shared representations that better satisfy properties (1), (2), and (3).

The system can use one or more multiple classifiers to enforce property (3). Using more classifiers tends to result in encoders that generalize better, but doing so also increases the training time.

The specification describes technologies to represent (embed) users as vectors in such a way that makes various classifiers efficient. A classifier is efficient if its performance is higher than a pre-defined metric. One can measure the performance of each classifier by using appropriate metrics; e.g., for a gender classifier one can use a specified accuracy, defined as a percentage of correct answers, as the metric.

One implementation of an adversarial network system described in this specification can use overlap between data points from pairs of sources. For example, when matching users with TV viewership data and users with Internet browsing history, a user visiting a URL where one can watch a certain TV show online can be matched with a user watching this same show on TV. Note that in this example, the fraction of overlapping signals is likely small, as the majority of clicked URLs likely do not belong to streaming sites.

After the encoders have been trained, the system can discard the classifiers entirely and merely use the encoders to generate user representations for other kinds of predictions.

One approach for inferring user's attributes from a collection of datasets by combining datasets of different types can include the following steps:
1. Encoding each user as a vector of zeros and ones where the i^{th} entry is one if the user has seen or visited the i^{th} signal, say a webpage or a TV show.
2. Using a dimensional reduction technique such as Principle Component Analysis (PCA) or Global Vector Embedding (GloVe) to compress the user vector to a smaller dimension.

In such an approach, users with overlapping signals are closer, on average, than users without overlapping signals. However, such an approach can lead to users being grouped together according to the dataset from which they come, thus being inefficient in merging the datasets in a useful way—useful in terms of supporting the real world problems presented above.

For example, a user in the TV dataset can end up being closer to a user from the same dataset than to a user from the Internet browsing dataset even though the former may look completely different (in terms of attributes: age, gender, interests, etc.) while the latter is similar in attributes.

A deficiency of such a solution is the incidental grouping of users by dataset and not by their higher-level attributes; this grouping can be detrimental to a classifier trained using user vectors created by such a solution.

In contrast, an approach described in this specification can use multiple encoders, one for each dataset in use. Each encoder can take a user from the corresponding dataset and return a numerical vector of a given size. In one implementation, the size is constant, e.g., the vector can contain 30 real numbers. The encoder for each dataset can be unique as each dataset has different features and users. Once all users from all the datasets are represented as 30-dimensional vectors, one can execute different queries based on the vectors' similarity. For example, given a user from a first dataset, one can find the most similar users from other datasets by looking for the most similar vectors to the vector of the first user. Vector similarity can be cosine similarity but any inner-product can be used for training and querying.

One can also develop and use classifiers that take the users 30-dimensional vectors and learn to predict a user's attributes, such as age, gender and interests, when given new users which the system has not seen before.

In general, one innovative aspect of the subject matter described in this specification can be embodied in methods that include the actions of: receiving, at each encoder of a plurality of encoders, individual user datasets for a plurality of individual users from a single specified source, the plurality of encoders receiving data from a plurality of data sources; generating a plurality of vectors, wherein generating a plurality of vectors comprises, for each individual user dataset, generating a vector of a specified size, the plurality of vectors forming a shared representation and wherein each of the plurality of encoders comprises a machine learning model trained based at least in part on: a) an encoder's loss, and b) a classifier loss; receiving a query of the shared representation; and providing information from the shared representation in response to the query.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. Generating a vector of a specified size can include: receiving a user history; and converting the user history in to a vector of signals. The machine learning model can be trained based at least in part on a discriminator loss that is based on vectors received from at least some of the plurality of encoders. The discriminator loss function can be based at least in part on cross entropy loss. The machine learning model can be trained based at least in part on a regularization loss. The encoder loss function can be a sum of a negative constant multiplied by the discriminator loss and a positive constant multiplied by the regularization loss. Providing information from the shared representation in response to the query can include determining at least one neighboring vector to a specified vector in the shared representation that meets a similarity threshold to the specified vector.

Another innovative aspect of the subject matter described in this specification can be embodied in methods that include the actions of: receiving data for a plurality of individual users from a plurality of data sources; determining a user's signals from the data; for each data source, combining the user's signals to create a user vector of a first fixed size; transforming the user vector by a neural network into a vector of a second fixed size, the neural network trained a) by determining a classifier loss, a discriminator loss and an encoder loss, and b) by adjusting the weights of the network to change the losses; receiving a query; and providing information in response to the query based on at least in part on the vector of the second fixed size. The first fixed size can be the same as the second fixed size. Combining the user's signals to create a user vector of a fixed size can include combining the user's signals using at least one of a summation, a weighted average and a recurrent neural network layer. The neural network can be trained a) by determining a classifier loss, a discriminator loss, an encoder loss, and a regularization loss and b) by adjusting the weights of the network to change the losses.

The subject matter described in this specification can be implemented in particular embodiments so as to realize one or more of the following advantages. In certain implementations, some of the machine learning models used in the technologies described in this specification are trained in an unsupervised manner which means these technologies do not need labeled data for training. Generating labeled data is time consuming and expensive if done manually. The technologies described in this specification can use existing datasets, unmodified, without generating additional labels.

In addition, the way the system merges the datasets enables a comparison of any two users from various sources for similarity. Users can be compared in a meaningful way due in part to two features: similar-behavior encoding and demographics classifiers. These modifications infuse a shared representation space with the users' behavior and properties, thus making responses to queries of similarity in this space meaningful and useful. Meaningful and useful responses means that implementations of an adversarial network system described in this specification can infer a user's attribute. For example, if the system matches attribute A (from source 1) with attribute B (from source 2) where sources 1 and 2 have some overlap in the sense mentioned before. If the system matches attribute B (from source 2) with attribute C (from source 3), then the system can infer a connection between attributes A and C even though sources 1 and 3 have no overlap. To be more specific, if a person watches a TV show and the system can match that person in the TV and Desktop datasets and the system can match that person between Desktop and Mobile attributes, then the system can match the person based on that person's original TV show viewership to some Mobile-related attribute.

Finally, implementations of the technology described in this specification can merge disjoint datasets—containing different users—and allow for hybrid users, having features from all the datasets combined, thus addressing the issue of partial data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an exemplary system for creating a shared representation from more than one data source.

FIG. 2 is a block diagram of an exemplary system showing a discriminator training flow.

FIG. 3 illustrates an example of shared features in a group of datasets.

FIG. 4 is a block diagram of an exemplary system showing the incorporation of a demographics classifier.

FIG. 5A is a flow chart showing an exemplary process for creating a representation of user derived from more than one data source.

FIG. 5B is a flow chart showing another exemplary process for creating a representation of user derived from more than one data source.

Like reference numbers and designations in the various drawings indicate like elements.

### DETAILED DESCRIPTION

This specification describes technologies for determining or inferring user attributes and/or determining information related to user attributes. As noted above, various datasets can provide information about individuals. Each dataset can have unique features. For example, one dataset can contain users' Internet browsing history (e.g., a list of URLs) while another dataset can contain TV viewership data (e.g., a list of TV shows for each user). One may want to determine or infer some of a user's attributes (such as age) from such datasets.

An approach described in this specification can use multiple encoders, one for each dataset being used. Each encoder takes a user from the corresponding dataset and returns a numerical vector of a given size. In one implementation, the size is constant, e.g., a vector can contain 30 real numbers. This range of potential values for the constant vector size can be between 1 and the dimension of the underlying user data, e.g., 200, being fed into the encoders. The dimension of the user data being fed into the encoders may vary; one approach is to select the dimension of the constant vector size that is the output of the encoders based on the smallest dimension of the user data being fed into any of the encoders.

The encoder for each dataset can be unique as each dataset has different features and users. Once all users from all the datasets are represented as fixed size vectors, e.g., 30-dimensional vectors, one can execute different queries based on the vectors' similarity. For example, given a user from a first dataset, one can find the most similar users from other datasets by looking for the most similar vectors to the vector of the first user. Vector similarity can be cosine similarity but any inner-product score can be used for sorting the vectors, then to be used in training and querying.

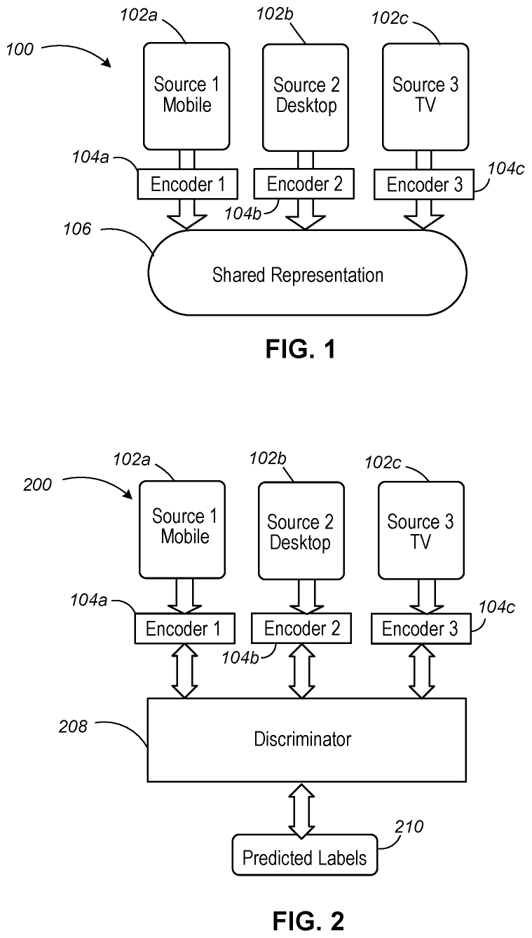

Next we present one implementation; this implementation is set of neural networks to be trained on given data. It can then be used on the given data and also on new never-seen-before data. A neural network is defined by its loss functions and architecture. Here “encoders” are neural networks, “classifiers” are neural networks and the “discriminator” is a neural network. The architecture is illustrated in FIGS. 1, 2, and 4 and exemplary loss functions are provided below.

FIG. 1 shows an example encoder based system 100. The system 100 includes multiple encoders 104a, 104b, 104c that receive data from data sources 102a, 102b, 102c, respectively. In one example, data sources 102a, 102b, and 102c can provide data from mobile devices, data from desktop computers and data from television sets, respectively. The encoders can in turn provide encoded data to a shared representation 106. The shared representation can be a database, e.g., a database that includes at least two columns: one column listing user-id and another column storing vectors where in one implementation each vector can be 30 real numbers. Querying the DB (database) can be based on distance between vectors. One can measure “distance” between vectors in different ways. One implementation determines distance using cosine similarity. The database can use a data structure that supports a distance-based query. One example of such a data structure is a k-dimensional tree.

### Discriminator Loss

As noted above, the encoders are neural networks that encode each user's features into a vector. The encoders are the end result of a machine learning approach, trained on datasets. The approach described in this specification can be based on a concept called Generative Adversarial Networks (GAN).

In GAN, there are two neural networks that compete against each other in the sense that they try to adjust a function and where one network's loss is the other network's gain. The two neural networks are called ‘generator’ and ‘discriminator’. The generator network tries to generate good (useful) samples, similar to training/real data. The discriminator tries to distinguish between the training samples and the generated samples. As the discriminator gets better in its task, the generator has to improve in order for the discriminator to not be able to distinguish generated samples from training/real samples. Thus the generator attempts to generate samples which look more and more like the real data. Mathematically, there is one loss function, i.e., discriminator loss, describing the classification task of the discriminator; while the discriminator tries to minimize it, the generator tries to maximize it at the same time. An example of this relationship between the generator (the encoders) and the discriminator is provided below.

With reference to FIG. 2, in one implementation, the generator in a GAN 200 described in this specification is represented by encoders e.g., 104a, 104b, 104c (one for each dataset 102a, 102b, 102c, respectively). The GAN 200 also includes a discriminator 208. The discriminator receives an encoded vector (e.g., a 30 dimensional vector) from one of the encoders (e.g., one of encoders 104a, 104b, 104c) and attempts to determine which source provided the data that resulted in the vector. Each vector can be labeled 210, with source labels determined by the discriminator. Through training, the discriminator gets better at determining the source of the data that resulted in the vector. Similarly the encoders get better at making users appear similar to one another in the shared representation space. The training length (e.g., how many training cycles to use to train the encoder) is a parameter that can be set based on preference of the user/trainer.

After encoding users, the system 200 can determine labels 210 for users using the discriminator. The discriminator loss for each source can be based on cross-entropy loss and all losses can then be multiplied to derive the total discriminator loss. This loss is back-propagated for the discriminator. The system can use other loss functions. Regarding the multiplication of loses, one can use addition, or other functions instead of, or in addition to, multiplication.

### Regularization Loss

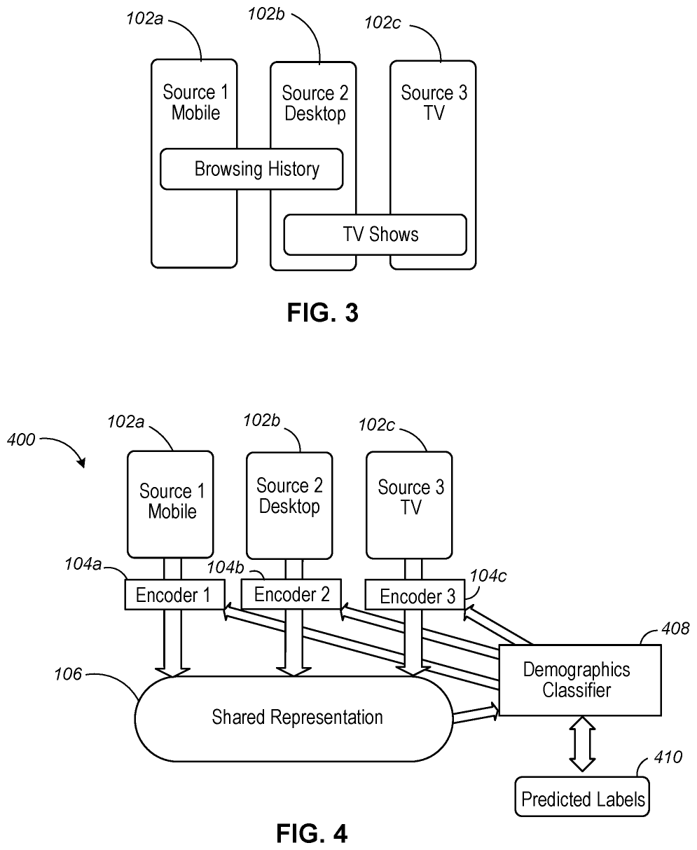

With reference to FIG. 3, the datasets can have shared features; for example, the mobile and desktop datasets 102a and 102b, respectively, both have URL visits logged where some URLs are shared between desktop and mobile. Another example is the desktop and TV datasets 102b and 102c, respectively, which share TV shows watched by users. In one implementation, the system can enforce similarity of the encoded vectors if they are derived from the same URL or TV show, even if they originated from different datasets. The system can require the encoders to facilitate this similarity enforcement; in the training phase, the system can: generate user pairs sharing the same “data” (e.g., desktop and mobile users visiting the same URL); encode the user pairs (each with its corresponding encoder); and then add the distance between the resulting vectors to the loss function. In one implementation the distance between the vectors is the distance between the endpoints of the vectors. Mathematically, if one has vectors A and B, one can take the difference C=A−B and calculate its (Euclidean) norm ∥C∥. These added distances are referred in the system as regularization loss; the regularization loss function is a function the encoder neural network reduces during the training phase, thus making these paired vectors closer to one another. Reducing the regularization loss function is a way for the system to have similar encodings if users have similar behavior.

For the similarity condition—which can also be referred to as a regularization term—the system can generate synthetic users; for example, the system can sample either a set of TV shows or URLs and generate synthetic users containing just this data; i.e., a mobile user who only visited “cnn.com” together with a desktop user who only visited “cnn.com” or similarly the system can generate a synthetic user with a single TV show. Once the system has generated these pairs, the system can encode the users and calculate the mean distance between all pairs, for TV and WEB, producing two numbers the system refers to as TV_distance and WEB_distance. Finally, these numbers are added to the encoders' loss and are minimized as part of the training loop; thus increasing the resulting similarity between sources for similar users.

### Classifier Loss

Some implementations leverage certain user data that exists in every dataset. For example, all the datasets can contain demographic data of the users (such as age and gender). The system can include a classification model for age and gender; the input can be a vector from the shared representation space and the output can be the age/gender labels. The system can use a single model for all the sources, treating them equally. FIG. 4 shows one example of a classification workflow.

With reference to FIG. 4, a classification workflow system 400 includes encoders, e.g., encoders 104a, 104b, and 104c, that receive data from various data sources, e.g., data sources 102a, 102b, and 102c, respectively. An encoder can encode user data from a data source into a vector that populates a shared representation 106. A demographic classifier 408 can receive user vector data from the shared representation 106 and can generate predicted labels 410.

Training a demographics classifier 408, as part of an overall training loop, requires the encoders to map users into the shared representation space in a non-trivial way, e.g., to preserve the demographics information from the original datasets into a single shared space.

For demographics classifiers, each classifier 408 produces a label for each user; loss can be based on cross entropy loss, all sources can be multiplied to determine total specified classifier loss and then all classifiers are added. The system can use other classifier loss functions. Regarding the multiplication of loses, one can use addition, or other functions instead of, or in addition to, multiplication.

### Model Training

In each iteration the system can take a batch of users from all sources and the system can encode user data coming from a specified source with its respective encoder. One implementation of a method described in this specification can train a demographics classifier on the resulting vectors. The system can generate a batch of user-pairs with “shared features” as described in the previous section and encode them. Finally, the discriminator can label the original source of each vector. In terms of loss functions, the encoders help minimize the demographics classifier loss. In addition, the encoders can try to maximize the discriminator's loss, thus reducing its ability to discriminate correctly from which source specified user data was derived.

One can use the PyTorch framework for model training. PyTorch is an open source machine learning library based on the Torch library, used for applications such as computer vision and natural language processing. PyTorch is free and open-source software. It provides two high-level features: tensor computing (like NumPy) with strong acceleration via graphics processing units (GPU) and deep neural networks built on a tape-based autodiff system (an automatic differentiation system).

PyTorch can define the network as a directed graph, starting with the inputs (the users) and then connecting the parts of the network. One implementation uses the loss functions noted above (examples of which are provided below). During the training phase PyTorch changes the parameters to change (e.g., minimize) the user-defined loss functions. The loss function is the last step and PyTorch performs back-propagation and modifies each link in the chain back to the inputs. “Back-propagation” is a technique used in neural network development and is the most common way to train neural networks. With regard to the classifiers, PyTorch can modify the encoders since they are a part in the graph connecting the input with the results of the classifiers. There are also loss functions for the encoders, not related to the classifiers. One can think of the loss functions as goals for PyTorch but achieving each goal can touch on many parts of the model.

The way PyTorch changes the parameters to minimize loss functions is determined on the optimization algorithm used. One implementation can use an Adam optimizer.

In machine learning and statistics, the learning rate is a tuning parameter in an optimization algorithm that determines the step size at each iteration while moving toward a minimum of a loss function. In order to achieve faster convergence, prevent oscillations and getting stuck in undesirable local minima the learning rate is often varied during training either in accordance to a learning rate schedule. One implementation can use a Cosine Annealing scheduling algorithm.

One implementation can employ a technique called label smoothing. For example, the labels for the discriminator in the 3-source case described below look like [1,0,0] if a user comes from the first source. Smoothing means one adds a random noise so the labels look like [0.84,0.12,0.04]. This leads to a robust model with better generalization on future users.

One can also use TensorFlow for model training. TensorFlow is a free and open-source software library for dataflow and differentiable programming across a range of tasks. It is a symbolic math library, and is also used for machine learning applications such as neural networks.

### An Example

As an example, assume 3 sources, and 3 demographics (age, gender and behavior). The training process can be composed of steps; each step is an iteration of an optimization step with a subset of the data, called a batch. The batch can be composed of an equal number of users, denoted by N “batch”, from each of the sources. Losses can be calculated for each step in the following manner: first a batch of users is taken from all 3 sources; then all the loss functions are calculated; finally an optimizer modifies the weights of the neural networks: encoders, classifiers and discriminator. This completes a single step of the training procedure, and the training system can repeat this process for many steps, e.g., for 10,000 steps.

The following describes the different loss functions that the system can modify.

### Classifiers Loss Function

Assume age, gender and behavior classifiers, denoted by A, G and B. Given a latent space vector v the classifiers prediction is written as A(v),G(v),B(v). The total loss is a linear combination:

$${L}_{classifier} = {α}_{age} {L}_{age} + {α}_{gender} {L}_{gender} + {α}_{behavior} {L}_{behavior} , \\ where$$

$${L}_{a g e} = {L}_{a g e , 1} \cdot {L}_{age , 2} \cdot {L}_{age , 3} , \\ {L}_{gender} = {L}_{g e n d e r , 1} \cdot {L}_{gender , 2} \cdot {L}_{gender , 3} , \\ {L}_{behavior} = {L}_{b e h a v i o r , 1} \cdot {L}_{behavior , 2} \cdot {L}_{behavior , 3} , \\ {L}_{a g e , i} = \frac{1}{{N}_{b a t c h}} {{\sum }_{n = 1}}^{{N}_{b a t c h}} {L}_{C E} ( A ( {E}_{i} ( {u}_{n , i} ) ) , {a}_{n , i} ) , \\ {L}_{gender , i} = \frac{1}{{N}_{b a t c h}} {{\sum }_{n = 1}}^{{N}_{b a t c h}} {L}_{C E} ( G ( {E}_{i} ( {u}_{n , i} ) ) , {g}_{n , i} ) , \\ {L}_{behvior , i} = \frac{1}{{N}_{b a t c h}} {{\sum }_{n = 1}}^{{N}_{b a t c h}} {L}_{C E} ( B ( {E}_{i} ( {u}_{n , i} ) ) , {b}_{n , i} ) ,$$

where L_{CE}(p,q)=−Σp log(q) is the cross entropy loss, Eᵢ is the encoder for the ith source, u_{n,i} is the nth user in the ith source and a_{n,i}, g_{n,i}, b_{n,i} are the true age/gender/behavior labels for the nth user in the ith source.

### Discriminator Loss Function

The discriminator is a neural network, denoted by D. It generates a 3 dimensional vector. The true labels are also 3 dimensional, for example the label for a user from source 1 is (1,0,0) while the label for a user in source 2 is (0,1,0). The loss can be:

$${L}_{D} = {L}_{D , 1} \cdot {L}_{D , 2} \cdot {L}_{D , 3} , \\ {L}_{D , i} = \frac{1}{{N}_{b a t c h}} {\sum }_{n = 1}^{{N}_{b a t c h}} {L}_{C E} ( D ( {E}_{i} ( {u}_{n , i} ) ) , {d}_{n , i} ) ,$$

where the system uses the cross entropy loss L_{CE} and d_{n,i} is the true source label for the nth user in the ith source.

### Encoders' Loss Function

As noted above, in neural network training, one usually uses the “back-propagation” method. Given a loss function and the original input, the method starts with the loss result and goes back in the computation graph by computing discrete differentiation of the loss function with respect to the input (e.g., the users). When doing back-propagation on the discriminator loss function, the system modifies the encoders weights as well, since the encoders are part of the computation graph, connecting the original input and the latent space vectors, which are an input to the discriminator. In GAN, this fact is used, as there is only one loss function where the discriminator tries to minimize and the generator tries to maximize (in the present model the generators are called encoders). The encoders loss can be:

L_{E}=−(1+α_{D})L_{D}+α_{reg.}L_{reg.},

where the first term's purpose is to undo the optimization of the encoders weights by doing back-propagation on the discriminator loss and the parameter can be selected, e.g., α_{D}=0.1. The second term is the regularization term:

$${L}_{reg .} = {α}_{TV} {L}_{TV} + {α}_{URL} {L}_{URL}$$

$${L}_{TV} = \frac{1}{{N}_{TV}} {\sum }_{n = 1}^{{N}_{T V}} ‖ {E}_{i} ( {v}_{n , i} ) - {E}_{j} ( {v}_{n , j} ) ‖$$

$${L}_{URL} = \frac{1}{{N}_{URL}} {\sum }_{n = 1}^{{N}_{URL}} ‖ {E}_{i} ( {v}_{n , i} ) - {E}_{j} ( {v}_{n , j} ) ‖ ,$$

where α_{TV}, α_{URL} are [symbol] (1) parameters (order unity), L_{TV} is the loss for doing TV matching, i.e., finding similar users on 2 sources who watched the same TV shows and summing over the Euclidean distance of their latent vectors and calculating the mean. Similarly, the L_{URL} is the web-based matching, i.e., finding similar users who visited the same URL and summing over the distances, finally calculating the mean.

### Aggregate Loss Function

The encoders loss function can be a function of the losses noted above and in one implementation includes the discriminator loss with negative sign with a numerical factor (e.g., 0.1 out of a range of 0 to 1). In one implementation, the encoders loss function can include the TV_distance and WEB_distance.

Training the encoders, classifiers and discriminator can happen in serial but the three contributions to the encoder training mentioned above can be taken into account in a parallel way. The order of the contributions can vary as long as it is consistent between the steps. One can think of a step as an infinitesimal slice of time where one changes the weights of all parts of the neural network system and then one moves to the next step in time. In a single step, the order in which the weights are changed does not alter the outcome.

### Demographics Classifiers

A system can use a variety of classifiers. For example, one can use one or more of various exemplary classifiers. The classifiers can be trained on the latent space representation and can help fine-tune the encoders so that the encoders include behavior information embedded in the latent space, i.e., the latent space is not a random arrangement of users from different sources. The first two classifiers can be age and gender. In addition, the system can include one or more of the following nine characteristics classifiers:
1. Sports fans.
2. Outdoors.
3. Travel.
4. Cooking.
5. Automotive.
6. Financial investors.
7. Politics.
8. Technology.
9. Busy Moms.
   These classifiers can be trained with training data determined using business pre-defined rules on URL visitation and TV viewership.

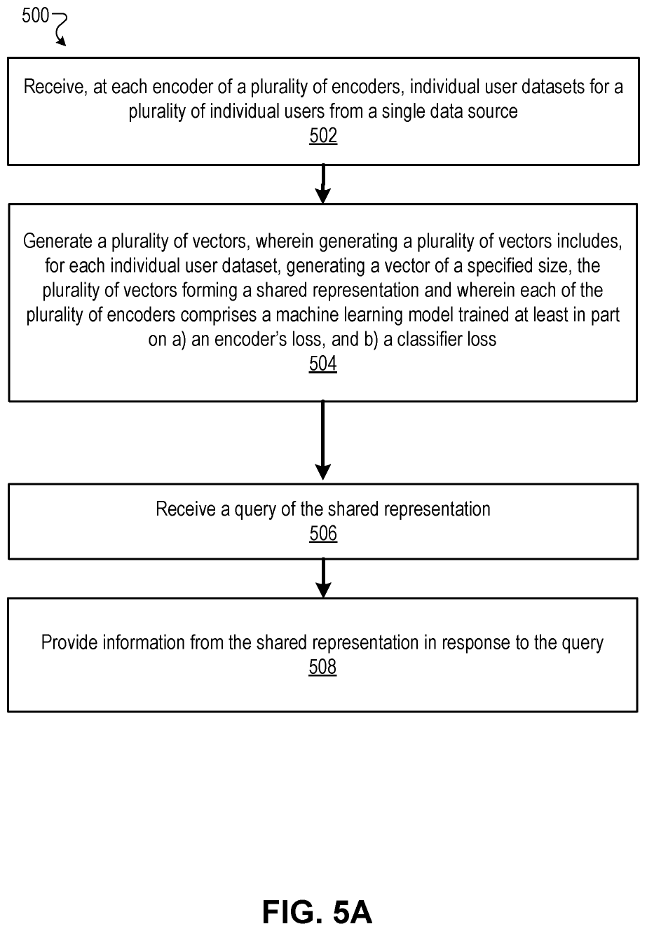

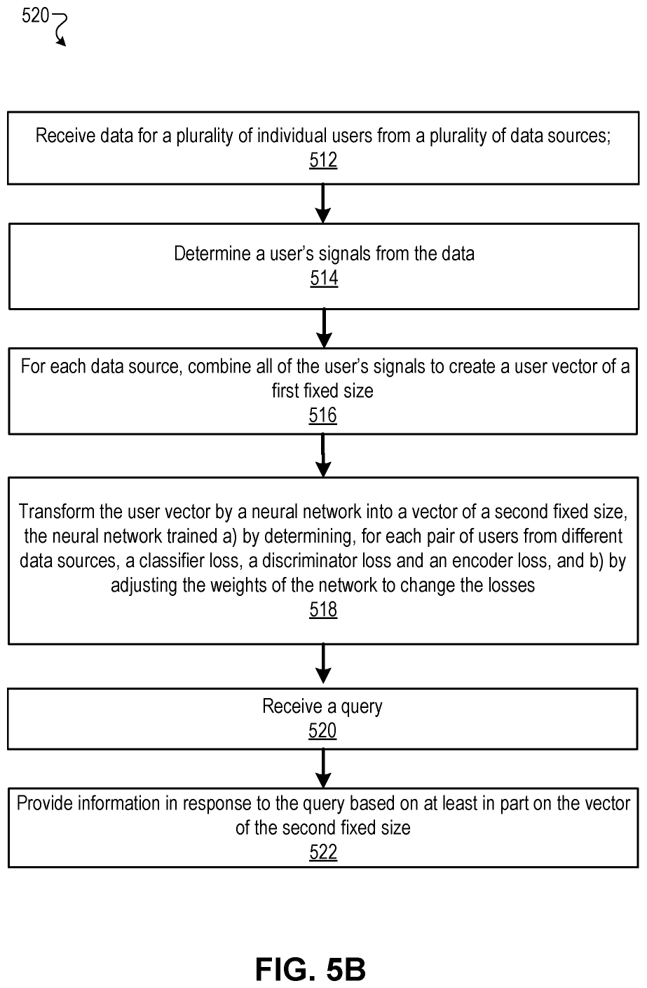

FIG. 5A is a flowchart of an example process 500 for creating a shared representation from more than one data source. For convenience, the process 500 will be described as being performed by a system of one or more computers, located in one or more locations, and programmed appropriately in accordance with this specification. For example, a system trained by a generative adversarial network, e.g., the GAN trained system 100 of FIG. 1, appropriately programmed, can perform the process 500.

The process 500 can include: receiving 502, at each encoder of a plurality of encoders, individual user datasets for a plurality of individual users from a single specified source, the plurality of encoders receiving data from a plurality of data sources; generating 504 a plurality of vectors, wherein generating a plurality of vectors comprises, for each individual user dataset, generating a vector of a specified size, the plurality of vectors forming a shared representation and wherein each of the plurality of encoders comprises a machine learning model trained at least in part on: a) an encoder's loss and b) a classifier's loss; receiving 506 a query of the shared representation; and providing 508 information from the shared representation in response to the query.

FIG. 5B is a flow chart showing another exemplary process 510 for creating a representation of a user derived from more than one data source. The process 510 can include: receiving 512 data for a plurality of individual users from a plurality of data sources; determining 514 a user's signals from the data; for each data source, combining 516 all of the user's signals to create a user vector of a first fixed size; transforming 518 the user vector by a neural network into a vector of a second fixed size, the neural network trained a) by determining, for each pair of users from different data sources, a classifier loss, a discriminator loss and an encoder loss, and b) by adjusting the weights of the network to reduce the losses; receiving 520 a query; and providing 522 information in response to the query based on at least in part on the vector of the second fixed size. The encoder loss can be a function of both the discriminator loss and a regularization loss.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving, at each encoder of a plurality of encoders, individual user datasets for a plurality of individual users from a single specified source, the plurality of encoders receiving data from a plurality of data sources;
generating a plurality of vectors, wherein generating a plurality of vectors comprises, for each individual user dataset, generating a vector of a specified size, the plurality of vectors forming a shared representation and wherein each of the plurality of encoders comprises a machine learning model trained based at least in part on: a) an encoder's loss, and b) a classifier loss;
receiving a query of the shared representation; and
providing information from the shared representation in response to the query.

2. The method of claim 1, wherein the generating a vector of a specified size comprises:
receiving a user history; and
converting the user history in to a vector of signals.

3. The method of claim 1, wherein the machine learning model is trained based at least in part on a discriminator loss that is based on vectors received from at least some of the plurality of encoders.

4. The method of claim 3, wherein the discriminator loss function is based at least in part on cross entropy loss.

5. The method of claim 3, wherein the machine learning model is trained based at least in part on a regularization loss.

6. The method of claim 5, wherein the encoder loss function is a sum of a negative constant multiplied by the discriminator loss and a positive constant multiplied by the regularization loss.

7. The method of claim 1, wherein providing information from the shared representation in response to the query comprises determining at least one neighboring vector to a specified vector in the shared representation that meets a similarity threshold to the specified vector.

8. A method comprising:
receiving data for a plurality of individual users from a plurality of data sources;
determining a user's signals from the data;
for each data source, combining the user's signals to create a user vector of a first fixed size;
transforming the user vector by a neural network into a vector of a second fixed size, the neural network trained a) by determining a classifier loss, a discriminator loss and an encoder loss, and b) by adjusting the weights of the network to change the losses;
receiving a query; and
providing information in response to the query based on at least in part on the vector of the second fixed size.

9. The method of claim 8, wherein the first fixed size is the same as the second fixed size.

10. The method of claim 8, wherein combining the user's signals to create a user vector of a fixed size comprises combining the user's signals using at least one of a summation, a weighted average and a recurrent neural network layer.

11. The method of claim 8, wherein the neural network is trained a) by determining a classifier loss, a discriminator loss, an encoder loss, and a regularization loss and b) by adjusting the weights of the network to change the losses.

12. The method of claim 11, wherein the encoder loss function is a sum of a negative constant multiplied by the discriminator loss and a positive constant multiplied by the regularization loss.

13. The method of claim 8, wherein receiving a query comprises receiving a query of a shared representation of user vectors and wherein providing information in response to the query comprises determining at least one neighboring user vector to a specified vector that meets a similarity threshold to the specified vector.

14. A system comprising:
one or more computers and one or more storage devices on which are stored instructions that are operable, when executed by the one or more computers, to cause the one or more computers to perform operations comprising:
receiving, at each encoder of a plurality of encoders, individual user datasets for a plurality of individual users from a single specified source, the plurality of encoders receiving data from a plurality of data sources;
generating a plurality of vectors, wherein generating a plurality of vectors comprises, for each individual user dataset, generating a vector of a specified size, the plurality of vectors forming a shared representation and wherein each of the plurality of encoders comprises a machine learning model trained based at least in part on: a) an encoder's loss, b) a classifier loss, and c) a discriminator loss that is based at least in part on vectors received from at least some of the plurality of encoders;
receiving a query of the shared representation; and
providing information from the shared representation in response to the query.

15. The system of claim 14, wherein the generating a vector of a specified size comprises:
receiving a user history; and
converting the user history in to a vector of signals.

16. The system of claim 14, wherein machine learning model is trained based at least in part on a discriminator loss that is based on vectors received from at least some of the plurality of encoders.

17. The system of claim 16, wherein the discriminator loss function is based at least in part on cross entropy loss.

18. The system of claim 16, wherein the machine learning model is trained based at least in part on a regularization loss.

19. The system of claim 18, wherein the encoder loss function is a sum of a negative constant multiplied by the discriminator loss and a positive constant multiplied by the regularization loss.

20. The system of claim 14, wherein providing information from the shared representation in response to the query comprises determining at least one neighboring vector to a specified vector in the shared representation that meets a similarity threshold to the specified vector.

21. The system of claim 14, wherein each of the plurality of encoders comprises a machine learning model trained with a plurality of different high-level classifiers; and the operations further comprise discarding all the classifiers after the encoders are trained.

22. The system of claim 21, wherein the operations further comprise using the trained encoders to generate user vectors.
